(19) United States
(12) Patent Application Publication
(10) Pub. No.: US 2026/0251942 A1
(43) Pub. Date: Aug. 27, 2026

(54) ARRAY SUBSTRATE, DISPLAY PANEL AND DISPLAY APPARATUS

(71) Applicants: NANJING BOE DISPLAY TECHNOLOGY CO., LTD., Nanjing (Jiangsu) (CN); BOE TECHNOLOGY GROUP CO., LTD., Beijing (CN)

(72) Inventors: Yang LIU, Beijing (CN); Haihong WANG, Beijing (CN); Honggang GU, Beijing (CN); Yang SHU, Beijing (CN); Shuangshuang HUANG, Beijing (CN)

(73) Assignees: NANJING BOE DISPLAY TECHNOLOGY CO., LTD., Nanjing (Jiangsu) (CN); BOE TECHNOLOGY GROUP CO., LTD., Beijing (CN)

(21) Appl. No.: 18/993,815

(22) PCT Filed: May 31, 2024
(86) PCT No.: PCT/CN2024/096676

§ 371 Date: Jan. 13, 2025

(30) Foreign Application Priority Data
Jun. 29, 2023 (CN) 202310786210.7

(51) Int. Cl. G02F 1/1362; G02F 1/1368

(52) U.S. Cl. CPC G02F 1/136286; G02F 1/136209; G02F 1/136227; G02F 1/1368

(57) ABSTRACT

An array substrate, a display panel and a display apparatus are provided, the array substrate includes a base substrate, a thin film transistor, a pixel electrode, a common electrode, a conductive pattern and a plurality of gate lines, and the thin film transistor includes a source electrode, a drain electrode and a gate electrode; the pixel electrode is electrically connected to the drain electrode; the common electrode is configured to form an electric field with the pixel electrode; the conductive pattern is located at a different layer from the common electrode; the gate line is electrically connected to the gate electrode of the thin film transistor, the conductive pattern is electrically connected to the common electrode, and an orthographic projection, on the base substrate, of the gate line at least partially overlaps with an orthographic projection, on the base substrate, of the conductive pattern.

The present disclosure claims priority to Chinese Patent Application No. 202310786210.7 filed on Jun. 29, 2023, the disclosure of which is incorporated herein by reference in its entirety.

### TECHNICAL FIELD

Embodiments of the present disclosure relate to an array substrate, a display panel, and a display apparatus.

### BACKGROUND

With the development of science and technology, self-media and film and television workers have a higher demand for image quality. For example, in 2017, a broadcast television station has switched from the display rate of 1080P to 4K ultra-high-definition television broadcasting and transmission, and mobile phone App gradually has a code stream of 4K ultra-high-definition video. At the same time, camera technology is also continuously improving, and some camera products already have 6K/8K video recording capability. At present, the medium-large dimension display products have a trend towards higher resolution. How to meet the dimension requirements of the product while improving the resolution of the product and having good display performance has become a difficult problem for display researchers.

### SUMMARY

At least one embodiment of the present disclosure provides an array substrate, a display panel and a display apparatus.

At least one embodiment of the present disclosure provides an array substrate, which includes a base substrate, a thin film transistor, a pixel electrode, a common electrode, a conductive pattern, and a plurality of gate lines, the thin film transistor is located on the base substrate, and the thin film transistor includes a source electrode, a drain electrode and a gate electrode; the pixel electrode is electrically connected to the drain electrode; the common electrode is configured to form an electric field with the pixel electrode; the conductive pattern is located at a different layer from the common electrode; the plurality of gate lines extend in a first direction, the plurality of gate lines are provided at intervals in a second direction, one of the plurality of gate lines is electrically connected to the gate electrode of the thin film transistor, the first direction and the second direction are both parallel to the base substrate, and the first direction intersects with the second direction, the conductive pattern is electrically connected to the common electrode, and an orthographic projection, on the base substrate, of the gate line at least partially overlaps with an orthographic projection, on the base substrate, of the conductive pattern.

For example, according to the array substrate provided by at least one embodiment of the present disclosure, the array substrate further includes an active pattern connected to the source electrode and the drain electrode of the thin film transistor, respectively, and at least partially overlapping with the gate electrode, an orthographic projection, on the base substrate, of the active pattern at most partially overlaps with the orthographic projection, on the base substrate, of the conductive pattern.

For example, according to the array substrate provided by at least one embodiment of the present disclosure, a spacing is provided between the orthographic projection, on the base substrate, of the active pattern and the orthographic projection, on the base substrate, of the conductive pattern.

For example, according to the array substrate provided by at least one embodiment of the present disclosure, the conductive pattern includes a plurality of conductive pattern units, and at least a portion of an orthographic projection, on the base substrate, of one of the plurality of conductive pattern units surrounds the orthographic projection, on the base substrate, of the active pattern.

For example, according to the array substrate provided by at least one embodiment of the present disclosure, at least a portion of the orthographic projection, on the base substrate, of the conductive pattern unit is in a shape of a closed loop or a non-closed loop.

For example, according to the array substrate provided by at least one embodiment of the present disclosure, adjacent conductive pattern units are at least partially connected to each other in the first direction.

For example, according to the array substrate provided by at least one embodiment of the present disclosure, the conductive pattern further includes a plurality of connection portions, one of the plurality of connection portions extends in the second direction, and both ends of the connection portion are respectively connected to two conductive pattern units adjacent in the second direction.

For example, according to the array substrate provided by at least one embodiment of the present disclosure, the array substrate further includes a plurality of data lines, one of the plurality of data lines extends in the second direction, and the data line is electrically connected to the source electrode, an orthographic projection, on the base substrate, of the connection portion falls into an orthographic projection, on the base substrate, of a portion of the data line between two conductive pattern units connected by the connection portion.

For example, according to the array substrate provided by at least one embodiment of the present disclosure, a width of the conductive pattern is greater than or equal to 3 μm.

For example, according to the array substrate provided by at least one embodiment of the present disclosure, the conductive pattern is located on one side, away from the base substrate, of the common electrode in a direction perpendicular to the base substrate.

For example, according to the array substrate provided by at least one embodiment of the present disclosure, in the direction perpendicular to the base substrate the common electrode is closer to the base substrate than the pixel electrode, and the conductive pattern is located between the common electrode and the pixel electrode.

For example, according to the array substrate provided by at least one embodiment of the present disclosure, the common electrode is farther away from the base substrate than the pixel electrode in the direction perpendicular to the base substrate.

At least one embodiment of the present disclosure further provides a display panel, which includes the array substrate according to any one of the above embodiments, and an opposite substrate provided opposite to the array substrate to form a cell.

For example, according to the display panel provided by at least one embodiment of the present disclosure, the opposite substrate includes a light-shielding pattern, and an orthographic projection, on the base substrate, of the conductive pattern, an orthographic projection, on the base substrate, of the data line and an orthographic projection, on the base substrate, of the gate line all fall within an orthographic projection, on the base substrate, of the light-shielding pattern.

For example, according to the display panel provided by at least one embodiment of the present disclosure, the light-shielding pattern includes a plurality of openings, and at least a portion of the pixel electrode is located in one of the plurality of openings, and the array substrate further includes a planarization layer, the planarization layer is located on one side, close to the conductive pattern, of the pixel electrode, the drain electrode is electrically connected to the pixel electrode through a via hole penetrating the planarization layer, and an orthographic projection, on the base substrate, of the via hole does not overlap with an orthographic projection, on the base substrate, of the conductive pattern unit.

For example, according to the display panel provided by at least one embodiment of the present disclosure, a minimum distance between the orthographic projection, on the base substrate, of the via hole and the orthographic projection, on the base substrate, of the conductive pattern unit is greater than or equal to 3.25 μm.

For example, according to the display panel provided by at least one embodiment of the present disclosure, in the second direction, a distance that an edge of the orthographic projection, on the base substrate, of the light-shielding pattern exceeds an edge of the orthographic projection, on the base substrate, of the gate line is greater than or equal to 0.5 μm.

For example, according to the display panel provided by at least one embodiment of the present disclosure, a minimum distance between an edge of an orthographic projection, on the base substrate, of the data line and an edge of the orthographic projection, on the base substrate, of the light-shielding pattern is greater than or equal to 0.5 μm.

For example, according to the display panel provided by at least one embodiment of the present disclosure, the display panel further includes a plurality of supporting structures, one of the plurality of supporting structures is located between the array substrate and the base substrate to support a cell thickness.

For example, according to the display panel provided by at least one embodiment of the present disclosure, the array substrate includes a top insulation layer located on one side, away from the base substrate, of the conductive pattern, the top insulation layer includes a first insulation portion and a second insulation portion connected to each other, the first insulation portion covers the conductive pattern, and an orthographic projection, on the base substrate, of the second insulation portion does not overlap at least a portion of the orthographic projection, on the base substrate, of the conductive pattern, and a position where the first insulation portion and the second insulation portion are connected to each other has a step difference in a direction perpendicular to the base substrate, a surface, away from the conductive pattern, of the first insulation portion is farther away from the base substrate than a surface, away from the conductive pattern, of the second insulation portion, and an orthographic projection, on the base substrate, of the supporting structure falls into the orthographic projection, on the base substrate, of the second insulation portion.

For example, according to the display panel provided by at least one embodiment of the present disclosure, at least a portion of the orthographic projection, on the base substrate, of the conductive pattern surrounds an orthographic projection, on the base substrate, of the supporting structure.

For example, according to the display panel provided by at least one embodiment of the present disclosure, in the second direction, portions, located at both sides of one supporting structure in the second direction, of the conductive pattern are connected to each other.

For example, according to the display panel provided by at least one embodiment of the present disclosure, in the first direction, portions of the conductive pattern between two adjacent supporting structures are at least partially disconnected from each other.

For example, according to the display panel provided by at least one embodiment of the present disclosure, in the second direction, areas of the orthographic projections, on the base substrate, of the portions, located at both sides of one supporting structure, of the conductive pattern are different.

For example, according to the display panel provided by at least one embodiment of the present disclosure, the array substrate has a first alignment layer, the opposite substrate has a second alignment layer, the plurality of supporting structures are provided on the opposite substrate, and the first alignment layer has a recess in a region enclosed by at least a portion of the conductive pattern to define a position of the supporting structure.

For example, according to the display panel provided by at least one embodiment of the present disclosure, the orthographic projection, on the base substrate, of the supporting structure at least partially overlaps with an orthographic projection, on the base substrate, of the recess.

For example, according to the display panel provided by at least one embodiment of the present disclosure, the orthographic projection, on the base substrate, of the supporting structure falls within the orthographic projection, on the base substrate, of the recess.

At least one embodiment of the present disclosure further provides a display apparatus, which includes the display panel according to any one of the above embodiments.

### BRIEF DESCRIPTION OF DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a partial structural schematic diagram of an array substrate provided by at least one embodiment of the present disclosure.

FIG. 2 is a schematic cross-sectional diagram of the array substrate of FIG. 1 taken along line A-A′.

FIG. 3 is a schematic cross-sectional diagram of the array substrate of FIG. 1 taken along line B-B′.

FIG. 4 is a schematic cross-sectional diagram of the array substrate of FIG. 1 taken along line C-C′.

FIG. 5 is a schematic cross-sectional diagram of the array substrate of FIG. 1 taken along line D-D′.

FIG. 6 is a schematic cross-sectional diagram of the array substrate of FIG. 1 taken along line E-E′.

FIG. 7 is a partial structural schematic diagram of another array substrate provided by at least one embodiment of the present disclosure.

FIG. 8 is a structural schematic diagram of a display panel.

FIG. 9 is a structural schematic diagram of a display panel provided by at least one embodiment of the present disclosure.

FIG. 10 is a partial cross-sectional diagram of the display panel of FIG. 9.

FIG. 11 is a partial structural schematic diagram of a conductive pattern in FIG. 10.

FIG. 12 is a partial structural schematic diagram of another conductive pattern.

FIG. 13 is a partial structural schematic diagram of yet another conductive pattern.

FIG. 14 is a partial structural schematic diagram of yet another conductive pattern.

FIG. 15 is a partial structural schematic diagram of yet another conductive pattern.

FIG. 16 is a partial schematic cross-sectional diagram of another display panel according to an embodiment of the present disclosure.

FIG. 17 is a partial structural schematic diagram of yet another conductive pattern.

FIG. 18 is a partial structural schematic diagram of yet another conductive pattern.

FIG. 19 is a partial structural schematic diagram of yet another conductive pattern.

FIG. 20 is a partial structural schematic diagram of yet another conductive pattern.

FIG. 21 is a schematic diagram of a connection between a display region and a peripheral region of the display panel provided by an embodiment of the present disclosure.

FIG. 22 is a partial structural schematic diagram of the display region in FIG. 21.

FIG. 23 is an enlarged diagram of a partial region of FIG. 22;

FIG. 24 is a schematic cross-sectional diagram of the array substrate of FIG. 21 taken along line M1-M1′.

FIG. 25 is a schematic cross-sectional diagram of the array substrate of FIG. 21 taken along line M2-M2′.

FIG. 26 is a schematic cross-sectional diagram of the array substrate of FIG. 21 taken along line M3-M3′.

FIG. 27 is a schematic cross-sectional diagram of the array substrate of FIG. 21 taken along line M4-M4′.

FIG. 28 is a schematic cross-sectional diagram of the array substrate of FIG. 21 taken along line M5-M5′.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise specified, the technical terms or scientific terms used in the disclosure shall have normal meanings understood by those skilled in the art. The words “first”, “second” and the like used in the disclosure do not indicate the sequence, the number or the importance but are only used for distinguishing different components. The word “comprise”, “include” or the like only indicates that an element or a component before the word contains elements or components listed after the word and equivalents thereof, not excluding other elements or components.

As used in embodiments of the present disclosure, the features “perpendicular”, “parallel”, and “identical” include the features “perpendicular”, “parallel”, and “identical,” etc. in the strict sense, as well as “approximately perpendicular”, “approximately parallel”, and “approximately identical,” etc., which include a certain amount of error, are indicated to be within a range of acceptable deviations for a particular value as determined by a person of ordinary skill in the art, taking into account the measurement and the error associated with the measurement of the particular quantity (e.g., the limitation of the measurement system). The “center” in the embodiments of the present disclosure may include a strictly geometric center position and a roughly central position in a small area around the geometric center.

With the rapid development of imaging technology, display products have a market demand for larger sizes and higher resolutions. At the same time, with the rapid delivery of Internet information, users are more aware of the display industry and pay more attention to their own visual experience.

However, in a study, the inventor of the present disclosure found that: for display products with a medium-large dimension (e.g. liquid crystal display products), the display panel generally includes an array substrate and an opposite substrate provided opposite to each other, and a pixel electrode and a common electrode may be provided in the array substrate. An electric field can be formed between the pixel electrode and the common electrode to drive liquid crystal molecules located between the array substrate and the opposite substrate to rotate, thereby realizing display. In response to that the uniformity of signal diffusion of the common electrode is poor, the occurrence of crosstalk or the like may lead to poor display. For example, for high-resolution products with a medium-large dimension, because of the limitation of square resistance of the common electrode, the signal uniformity of the common electrode is not good, and upon the product being running (for example, upon a picture being reloaded), there may be a crosstalk problem upon the Excel document being used, which affects the user's visual experience upon the user using the Excel to work. Of course, the crosstalk problem described above is not limited to scenarios upon Excel documents being used. For example, a width-to-length ratio of a display screen of the display product with a medium-large dimension described above may be 16:9. For example, the dimension of the display screen may be 597.6 mm×336.15 mm, but is not limited thereto.

Therefore, it is necessary to reduce the square resistance of the common electrode in the array substrate so as to improve the uniformity of signal transmission, and at the same time, the technical solution of reducing the square resistance of the common electrode should also have less influence on a pixel opening ratio of the product so as to facilitate display.

At least one embodiment of the present disclosure provides an array substrate, a display panel, and a display apparatus.

An array substrate provided by at least one embodiment of the present disclosure includes a base substrate, a thin film transistor, a pixel electrode, a common electrode, a conductive pattern, and a plurality of gate lines, the thin film transistor is located on the base substrate, and the thin film transistor includes a source electrode, a drain electrode and a gate electrode; the pixel electrode is electrically connected to the drain electrode; the common electrode is configured to form an electric field with the pixel electrode; the conductive pattern is located at a different layer from the common electrode; the plurality of gate lines extend in a first direction, the plurality of gate lines are provided at intervals in a second direction, one of the plurality of gate lines is electrically connected to the gate electrode of the thin film transistor, the first direction and the second direction are both parallel to the base substrate, and the first direction intersects with the second direction, the conductive pattern is electrically connected to the common electrode, and an orthographic projection, on the base substrate, of the gate line at least partially overlaps with an orthographic projection, on the base substrate, of the conductive pattern.

The array substrate provided by the embodiments of the present disclosure can effectively reduce the square resistance of the common electrode and improve the uniformity upon the signal of the common electrode diffusing by increasing the conductive pattern electrically connected to the common electrode, thereby reducing the probability of crosstalk occurring in the display product, so as to improve the display effect; at the same time, by at least partially overlapping the orthographic projection, on the base substrate, of the gate line with the orthographic projection, on the base substrate, of the conductive pattern, a layout area occupied by the conductive pattern can be reduced and the pixel opening ratio can be made larger to facilitate display.

Below, the array substrate, the display panel, and the display apparatus provided in the embodiments of the present disclosure will be described in conjunction with the accompanying drawings.

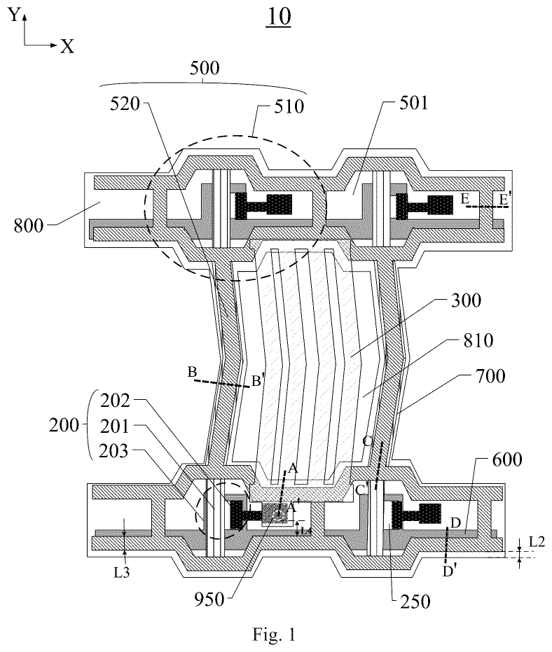

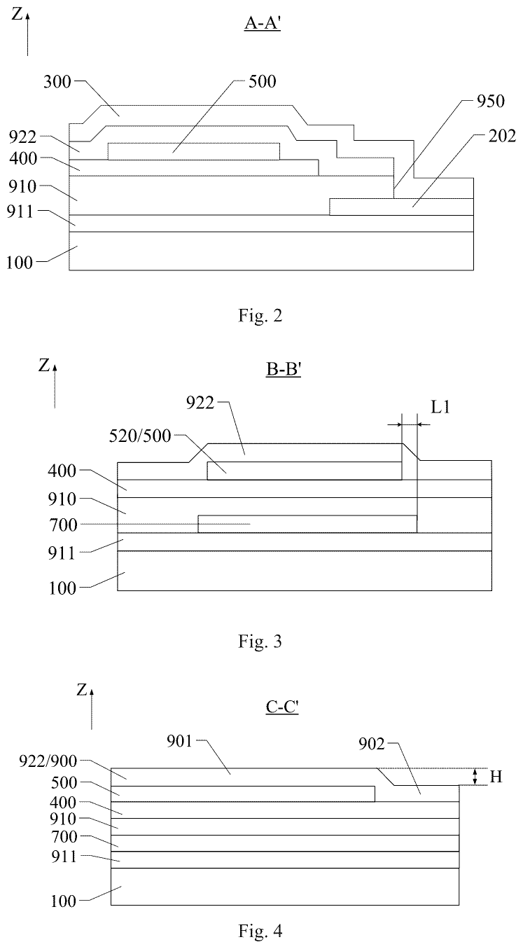

FIG. 1 is a partial structural schematic diagram of an array substrate provided by at least one embodiment of the present disclosure; FIG. 2 is a schematic cross-sectional diagram of the array substrate of FIG. 1 taken along line A-A′.

As shown in FIG. 1 and FIG. 2, an array substrate 10 includes a base substrate 100, a thin film transistor 200, a pixel electrode 300, and a common electrode 400, the thin film transistor 200 is located on the base substrate 100, and the thin film transistor 200 includes a source electrode 201, a drain electrode 202, and a gate electrode 203. The pixel electrode 300 is electrically connected to the drain electrode 202 of the thin film transistor 200, and the common electrode 400 is configured to form an electric field with the pixel electrode 300. For example, one side of the array substrate 10 may be provided with a liquid crystal layer (not shown), and the electric field formed between the pixel electrode 300 and the common electrode 400 can drive the liquid crystal molecules to deflect, so as to preform display.

As shown in FIG. 1 and FIG. 2, the array substrate 10 further includes a conductive pattern 500, the conductive pattern 500 is electrically connected to the common electrode 400 and located at a different layer from the common electrode 400. For example, as shown in FIG. 2, the conductive pattern 500 may be in direct contact with the common electrode 400 to facilitate electrical signal transmission therebetween, which is not limited thereto. For example, in some embodiments, an insulation layer may also be provided between the conductive pattern 500 and the common electrode 400, and a via hole may be provided in the insulation layer so that the common electrode 400 and the conductive pattern 500 are electrically connected through the via hole, and the embodiments of the present disclosure do not limit this.

As shown in FIGS. 1 and 2, the array substrate 10 further includes a plurality of gate lines 600. The gate line 600 extends in a first direction X, and the plurality of gate lines 600 are provided at intervals in a second direction Y, and the gate line 600 is electrically connected to the gate electrode 203 of the thin film transistor 200 to control a conduction condition between the source electrode 201 and the drain electrode 202 of the thin film transistor 200. An orthographic projection, on the base substrate 100, of the gate line 600 at least partially overlaps with an orthographic projection, on the base substrate 100, of the conductive pattern 500.

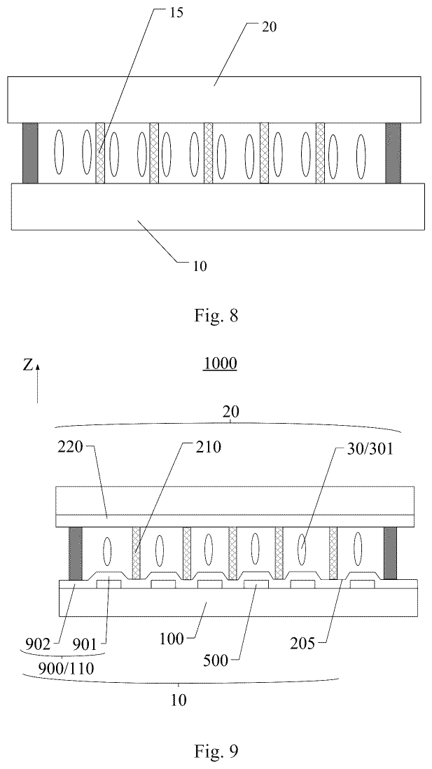

For example, an opposite substrate may also be provided on an opposite side of the array substrate 10 as shown in FIG. 1 (refer to, for example, FIG. 8-9). The opposite substrate includes a light-shielding pattern 800, the light-shielding pattern 800 has an opening 810, and the pixel electrode 300 is located in the opening 810. For example, the opening of the light-shielding pattern 800 may define a pixel region to control a light-emitting region of the pixel. A portion, other than the opening 810, of the light-shielding pattern 800 may shade structures in the array substrate 10 to reduce the risk of light leakage and the like. For example, the light-shielding pattern 800 may cover each signal line in the array substrate 10, such as the gate line 600, the conductive pattern 500, the data line, etc. but is not limited thereto. Therefore, upon the orthographic projection, on the base substrate 100, of the conductive pattern 500 at least partially overlaps with the orthographic projection, on the base substrate 100, of the gate line 600, the influence of providing the conductive pattern 500 on the pixel opening ratio can be minimized. For example, the pixel opening ratio of the array substrate 10 can be substantially unchanged after providing the conductive pattern 500, so as to facilitate display. That is, the orthographic projection, on the base substrate 100, of the conductive pattern 500 at least partially overlaps with the orthographic projection, on the base substrate 100, of the gate line 600 such that the pixel opening ratio is not reduced by the provision of the conductive pattern 500.

As shown in FIG. 1 and FIG. 2, the first direction X and the second direction Y are both parallel to the base substrate 100, and the first direction X intersects with the second direction Y. For example, the first direction X may be perpendicular to the second direction Y.

As shown in FIGS. 1 and 2, the array substrate 10 provided by the embodiments of the present disclosure can effectively reduce the square resistance of the common electrode 400 and improve the uniformity upon the signal of the common electrode 400 diffusing by increasing the conductive pattern 500 electrically connected to the common electrode 400, thereby reducing the probability of crosstalk occurring in the display product, so as to improve the display effect; at the same time, by at least partially overlapping the orthographic projection, on the base substrate 100, of the gate line 600 with the orthographic projection, on the base substrate 100, of the conductive pattern 500, a layout area occupied by the conductive pattern 500 can be reduced and the pixel opening ratio can be made larger to facilitate display.

For example, as shown in FIG. 1, in the second direction Y, an edge of the orthographic projection, on the base substrate 100, of the conductive pattern 500 may be located beyond an edge of the orthographic projection, on the base substrate 100, of the gate line 600 by, for example, a distance greater than or equal to 0.5 μm. For example, a portion of the orthographic projection, on the base substrate 100, of the gate line 600 is covered by the orthographic projection, on the base substrate 100, of the conductive pattern 500. For example, in the first direction X, an orthographic projection, on the base substrate 100, of a portion of the conductive pattern 500 located between two adjacent thin film transistors 200 and extending in the first direction X covers at least a portion of the gate line 600.

For example, as shown in FIG. 1, in the second direction Y, a dimension of a portion where the orthographic projection, on the base substrate 100, of the conductive pattern 500 overlaps with the orthographic projection, on the base substrate 100, of the gate line 600 is 30% to 90% of a dimension of the gate line 600, and may be, for example, at least one of 30% to 70%, 40% to 60%, 45% to 75%, and 50% to 60% of the dimension of the gate line 600, but is not limited thereto. For example, in order to reduce the dimension of the conductive pattern 500 in the second direction Y, an overlapping area between the conductive pattern 500 and the gate line 600 may be increased as much as possible, thereby facilitating a larger pixel opening ratio for display.

For example, as shown in FIG. 1, the array substrate 10 further includes an active pattern 250. The active pattern 250 is connected to the source electrode 201 and the drain electrode 202 of the thin film transistor 200, respectively, and at least partially overlaps with the gate electrode 203. For example, in the first direction X, the source electrode 201 and the drain electrode 202 are provided on both sides of the active pattern 250, respectively. For example, the source electrode 201 and the drain electrode 202 may be located on one same layer, and an insulation layer may be provided between the same layer and the active pattern 250, and the source electrode 201 and the drain electrode 202 may be respectively connected to the active pattern 250 through a via hole penetrating the insulation layer, but it is not limited thereto.

For example, in an embodiment of the present disclosure, the active pattern 250 is made of a semiconductor material. For example, the material of the active pattern 250 includes amorphous silicon, low temperature polysilicon, or an oxide semiconductor material, but it is not limited thereto.

For example, as shown in FIG. 1, an orthographic projection, on the base substrate 100, of the active pattern 250 at most partially overlaps with an orthographic projection, on the base substrate 100, of the conductive pattern 500. That is, the orthographic projection, on the base substrate 100, of the active pattern 250 and the orthographic projection, on the base substrate 100, of the conductive pattern 500 are at least partially non-overlapping, or completely non-overlapping. For example, the conductive pattern 500 may include a plurality of hollow portions 501, and at least a portion of the orthographic projection, on the base substrate 100, of the active pattern 250 may be located in a region enclosed by the orthographic projection, on the base substrate 100, of the hollow portion 501, such that in a direction perpendicular to the base substrate 10 (a third direction Z), the active pattern 250 is not completely covered by the conductive pattern 500 to expose at least a portion of the active pattern 250 through the hollow portion 501.

With such arrangement, the active pattern 250 or at least a portion of a structure connected to the active pattern 250 may not be covered by the conductive pattern 500 to facilitate observation of an operating state of the thin film transistor 200 (for example, which may be observed by a microscope) to facilitate servicing and maintenance in the event of a failure of the thin film transistor 200.

In an embodiment of the present disclosure, the third direction Z is perpendicular to the first direction X and perpendicular to the second direction Y.

For example, as shown in FIG. 1, a spacing is provided between the orthographic projection, on the base substrate 100, of the active pattern 250 and the orthographic projection, on the base substrate 100, of the conductive pattern 500. For example, the orthographic projection, on the base substrate 100, of the active pattern 250 may be located entirely within the region enclosed by the orthographic projection, on the base substrate, of the hollow portion 501 of the conductive pattern 500 to facilitate observation of the operating state of the thin film transistor 200.

For example, as shown in FIG. 1, the conductive pattern 500 includes a plurality of conductive pattern units 510. The orthographic projection, on the base substrate 100, of the conductive pattern unit 510 at least partially surrounds the orthographic projection, on the base substrate 100, of the active pattern 250. For example, the plurality of conductive pattern units 510 may correspond to a plurality of thin film transistors 200 on a one-to-one basis, and a quantity of the conductive pattern units 510 in the array substrate 10 may be equal to a quantity of thin film transistors 200, but it is not limited thereto. For example, at least a portion of the orthographic projection, on the base substrate 100, of the thin film transistor 200 may not be covered by the orthographic projection, on the base substrate 100, of the conductive pattern 500 to facilitate observation of its operating state.

For example, as shown in FIG. 1, at least a portion of the orthographic projection, on the base substrate 100, of the conductive pattern unit 510 is in a shape of a closed loop. For example, the above-mentioned loop is not limited to a circular ring, and may be, for example, a polygon, an ellipse, a triangle, etc. which is not limited by the embodiments of the present disclosure. For example, at least a portion of the orthographic projection, on the base substrate 100, of the conductive pattern unit 510 may be, but is not limited to, an octagonal loop.

For example, as shown in FIG. 1, at least a portion of the orthographic projection, on the base substrate 100, of the conductive pattern unit 510 may also be in a shape of an non-closed loop, for example, may be in a shape of a notched ring, for example, a semi-circle and the like, such that a portion of the conductive pattern unit 510 is provided around the thin film transistor 200.

For example, as shown in FIG. 1, at least portions of adjacent conductive pattern units 510 are connected to each other in the first direction X, so that an overall square resistance of the conductive pattern 500 can be reduced to facilitate uniformity of the signal delivered by the common electrode 400.

For example, as shown in FIG. 1, the conductive pattern 500 further includes a plurality of connection portions. For example, the plurality of connection portions may be the first connection portions 520 shown in FIG. 1. For example, the first connection portion 520 extends in the second direction Y, and both ends of the first connection portion 520 are respectively connected to two conductive pattern units 510 adjacent in the second direction Y, so that the overall square resistance of the conductive pattern 500 can be further reduced to facilitate uniformity of the signal transmitted by the common electrode 400. For example, but not by way of limitation, the conductive pattern 500 may be a unitary “mesh” structure such that the signal delivered by the common electrode 400 can be transmitted in all directions to facilitate signal uniformity. For example, one pixel electrode 300 is provided between two adjacent first connection portions 520, and the greater the distance between the two adjacent first connection portions 520 in the first direction X, the greater the pixel opening ratio.

FIG. 3 is a schematic cross-sectional diagram of the array substrate of FIG. 1 taken along line B-B′.

For example, as shown in FIG. 1 and FIG. 3, the array substrate 10 further includes a plurality of data lines 700, the data line 700 extends in the second direction Y, and the data line 700 is electrically connected to the source electrode 201 of the thin film transistor 200. The orthographic projection, on the base substrate 100, of the first connection portion 520 falls into the orthographic projection, on the base substrate 100, of the portion of the data line 700 between the two conductive pattern units 510 to which the first connection portion 520 is connected.

For example, as shown in FIG. 1 and FIG. 3, in the second direction Y, the trends of the data line 700 and the first connection portion 520 between two adjacent conductive pattern units 510 are substantially the same, and a width of the first connection portion 520 is substantially the same as a width of the data line 700, so that the influence of the first connection portion 520 on the pixel opening ratio can be reduced.

For example, as shown in FIG. 1 and FIG. 3, a minimum distance L1 between an edge of the orthographic projection, on the base substrate 100, of the data line 700 and an edge of the orthographic projection, on the base substrate 100, of the conductive pattern 500 is greater than or equal to 0.5 μm. For example, a width of the orthographic projection, on the base substrate 100, of the conductive pattern 500 is less than a width of the orthographic projection, on the base substrate 100, of the data line 700, thereby facilitating an increase in the pixel opening ratio. For example, the minimum distance L1 may be at least one of 0.5 μm to 0.9 μm, 0.5 μm to 0.8 μm, 0.6 μm to 0.7 μm, and 0.55 μm to 0.75 μm, but is not limited thereto.

For example, as shown in FIG. 1, the orthographic projection, on the base substrate 100, of the conductive pattern 500, the orthographic projection of, on the base substrate 100, the data line 700 and the orthographic projection, on the base substrate 100, of the gate line 600 all fall within the orthographic projection, on the base substrate 100, of the light-shielding pattern 800 to reduce interference with the pixel display.

For example, as shown in FIG. 1, the distance L2 that an edge of an orthographic projection, on the base substrate 100, of the light-shielding pattern 800 exceeds an edge of the orthographic projection, on the base substrate 100, the gate line 600 is greater than or equal to 0.5 μm, and may be at least one of 0.5 μm to 0.9 μm, 0.5 μm to 0.8 μm, 0.6 μm to 0.7 μm, and 0.55 μm to 0.75 μm, for example, but is not limited thereto.

For example, as shown in FIG. 1, a width L3 of the conductive pattern 500 is greater than or equal to 3 μm, and may be at least one of 3.1 μm to 3.5 μm, 3.2 μm to 3.6 μm, 3.3 um to 3.7 μm, and 3.4 μm to 3.8 μm, for example, so that the pixel opening ratio can be made large while reducing the overall square resistance of the conductive pattern 500 to facilitate the uniformity of the signal delivered by the common electrode 400.

For example, as shown in FIGS. 1 and 2, the array substrate 10 further includes a planarization layer 910, which is located at one side, close to the conductive pattern 500, of the pixel electrode 300, and the drain electrode 202 is electrically connected to the pixel electrode 300 through a via hole 950 penetrating the planarization layer 910. For example, as shown in FIG. 1, the orthographic projection, on the base substrate 100, of the via hole 950 does not overlap with the orthographic projection, on the base substrate 100, of the conductive pattern unit 510. For example, an orthographic projection, on the base substrate 100, of the via hole 950 is located in the region enclosed by the orthographic projection, on the base substrate 100, of the conductive pattern unit 510, and, for example, may be located in the hollow portion 501 described above. With such arrangement, the connection situation of the drain electrode 202 to the pixel electrode 300 at the via hole 950 can be advantageously detected.

For example, as shown in FIG. 1, a minimum distance L4 between the orthographic projection, on the base substrate 100, of the via hole 950 and the orthographic projection, on the base substrate 100, of the conductive pattern unit 510 is greater than or equal to 3.25 μm, so as to reduce the influence of the conductive pattern 510 on the connection situation at the via hole 950. For example, the minimum distance L4 may be at least one of 3.25 μm to 3.50 μum, 3.35 μm to 3.65 μm, 3.45 μm to 3.75 μm, and 3.55 μm to 3.85 μm, but is not limited thereto.

For example, as shown in FIG. 1 and FIG. 2, in the direction perpendicular to the base substrate 100, that is, in the third direction Z shown in FIG. 2, a first insulation layer 911 is provided on the base substrate 100, and the drain electrode 202 and the source electrode 201 of the thin film transistor 200 are provided on the same layer and are both located on the first insulation layer 911. The planarization layer 910 is provided on the drain electrode 202. A common electrode 400 is provided on the planarization layer 910. For example, the common electrode 400 may be made of a transparent material such as, but not limited to, ITO (Indium tin oxide).

For example, as shown in FIG. 1 and FIG. 2, the conductive pattern 500 is located on the side, away from the base substrate 100, of the common electrode 400. For example, a second insulation layer 922 is further provided between the conductive pattern 500 and the pixel electrode 300. For example, in the third direction Z, the common electrode 400 is closer to the base substrate 100 than the pixel electrode 300, and the conductive pattern 500 is located between the common electrode 400 and the pixel electrode 300, but it is not limited thereto. For example, the pixel electrode 300 may be made of a transparent conductive material, and, for example, the pixel electrode 300 may employ the same material as the common electrode 400, but it is not limited thereto.

For example, as shown in FIG. 1 and FIG. 3, the data line 700 may be located on the same layer as the drain electrode 202 and the source electrode 201 of the thin film transistor 200 and both located on the first insulation layer 911, so as to facilitate the connection of the data line 700 with the source electrode 201. For example, the data line 700, the source electrode 201, and the drain electrode 202 may adopt the same conductive material and be formed by the same process, but are not limited thereto.

FIG. 4 is a schematic cross-sectional diagram of the array substrate of FIG. 1 taken along line C-C′.

For example, as shown in FIG. 1 and FIG. 4, the first insulation layer 911, the data line 700, the planarization layer 910, the common electrode 400, and the conductive pattern 500 are sequentially stacked on the base substrate 100 at a position that the line C-C′ cuts. The second insulation layer 922 is provided on the conductive pattern 500, and a thickness of the second insulation layer 922 is substantially uniform.

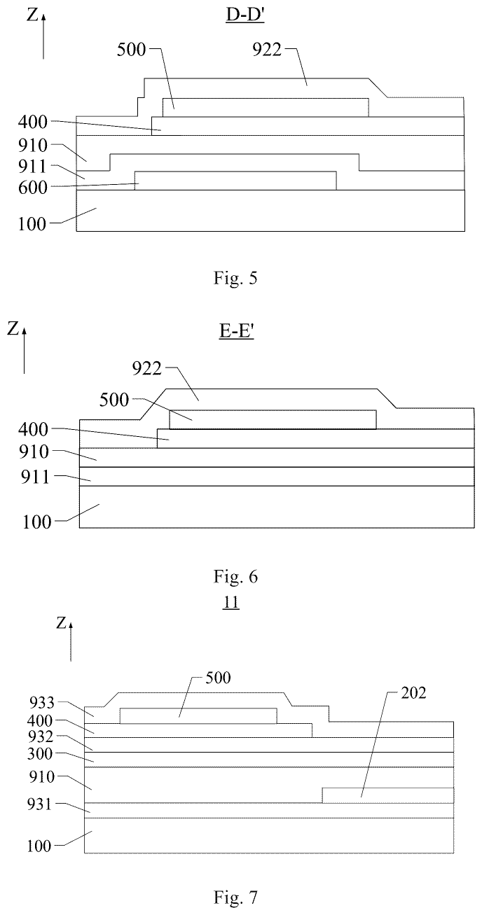

FIG. 5 is a schematic cross-sectional diagram of the array substrate of FIG. 1 taken along line D-D′.

For example, as shown in FIGS. 1 and 5, the gate line 600, the first insulation layer 911, the planarization layer 910, the common electrode 400, the conductive pattern 500, and the second insulation layer 922 are sequentially provided at a position that a line D-D′ cuts. The orthographic projection, on the base substrate 100, of the gate line 600 at least partially overlaps with the orthographic projection, on the base substrate 100, of the conductive pattern 500, so as to reduce the effect of the conductive pattern 500 on the pixel opening ratio. For example, in some embodiments of the present disclosure, the width of the conductive pattern 500 may be approximately equal to the width of the gate line 600, but is not limited thereto.

FIG. 6 is a schematic cross-sectional diagram of the array substrate of FIG. 1 taken along line E-E′.

For example, as shown in FIG. 1 and FIG. 6, the first insulation layer 911, the planarization layer 910, the common electrode 400, the conductive pattern 500, and the second insulation layer 922 are sequentially provided on the base substrate 100 at a position that the line E-E′ cuts. For example, at this position, the orthographic projection, on the base substrate 100 of the conductive pattern 500 falls into the orthographic projection, on the base substrate 100, of the common electrode 400, but it is not limited thereto.

For example, as shown in FIG. 1, in the array substrate 10, the film layer where the gate line 600 is located may be a first metal layer, the film layer where the data line 700 (as shown in FIG. 4), the source electrode 201 and the drain electrode 202 are located may be a second metal layer, and the film layer where the conductive pattern 500 is located may be a third metal layer, but it is not limited thereto.

For example, in some embodiments of the present disclosure, the relative positions of the common electrode and the pixel electrode in the direction perpendicular to the base substrate may be flexibly adjusted according to design requirements, so long as an electric field for driving the liquid crystal to deflect is formed therebetween.

FIG. 7 is a partial structural schematic diagram of another array substrate provided by at least one embodiment of the present disclosure.

For example, in the array substrate 11 provided in some embodiments, the structure of the array substrate 11 at the corresponding position is as shown in FIG. 7 with reference to the position that the line A-A′ cuts in FIG. 1, that is, the common electrode 400 may be farther away from the base substrate 100 than the pixel electrode 300. The array substrate 11 shown in FIG. 7 differs from the array substrate 10 in that the relative positional relationships between the common electrode 400 and the pixel electrode 300 are different, and the remaining structures can be seen from the relevant description of the above-mentioned embodiments, and the description will not be repeated here.

For example, as shown in FIG. 7, in the third direction Z, the first insulation layer 931, the drain electrode 202, and the planarization layer 910 are sequentially provided. The pixel electrode 300 is provided on the planarization layer 910, and the second insulation layer 932 is provided on the pixel electrode 300. The common electrode 400 and the conductive pattern 500 are sequentially provided on the second insulation layer 932, and the third insulation layer 933 is provided on the conductive pattern 500. For example, an electric field may be formed between the pixel electrode 300 and the common electrode 400 to drive the liquid crystal to deflect. For example, the pixel electrode 300 may be made of the same material as the common electrode 400, such as, but not limited to, ITO. The conductive pattern 500 in the array substrate 11 is located farther away from the base substrate 100 than the array substrate shown in FIG. 6, and such arrangement can, for example, facilitate flexible placement of the structure of the conductive pattern 500 to accommodate more design requirements.

FIG. 8 is a schematic structural diagram of a display panel.

Generally, as shown in FIG. 8, the array substrate 10 and the opposite substrate 20 are provided in a medium-large-size and high-resolution display product, and the opposite substrate 20 is provided opposite to the array substrate 10. For example, a plurality of supporting structures 15 may be provided on the opposite substrate 20 to support the array substrate 10 and the opposite substrate 20. For example, the layer, facing the opposite substrate 20, of the array substrate 10 is typically an insulation layer that can protect the array substrate 10. For example, the insulation layer may also be an alignment layer to enable uniform and stable arrangement of the crystal. However, because the supporting structure 15 is in direct contact with the insulation layer or the alignment layer, the supporting structure 15 is easily displaced during the process of arranging the opposite substrate 20 and the array substrate 10 in a cell, thereby scratching the surface of the insulation layer or the alignment layer, and thus easily causing poor display such as Mura.

FIG. 9 is a structural schematic diagram of a display panel according to at least one embodiment of the present disclosure.

Thus, as shown in FIG. 9, the embodiments of the present disclosure also provide a display panel 1000. The display panel 1000 includes the array substrate 10 and the opposite substrate 20 described in any one of the above-mentioned embodiments, and the opposite substrate 20 is provided opposite to the array substrate 10 to form the cell. The display panel 1000 also includes a plurality of supporting structures 210 located between the array substrate 10 and the opposite substrate 20 to support a thickness of the cartridge. For example, the array substrate in the embodiments described below is illustrated with the array substrate 10 shown in FIG. 1, but is not limited thereto.

For example, as shown in FIG. 9, a liquid crystal layer 30 is provided within the cell. The liquid crystal layer 30 includes a plurality of liquid crystal molecules 301. In some embodiments, the side, facing the array substrate 10, of the opposite substrate 20 may be provided with a filter layer to achieve a color display. For example, the filter layer includes a plurality of filter units, and each filter unit may correspond to one display electrode. For example, the plurality of filter units may include a plurality of red filter units, a plurality of green filter units, and a plurality of blue filter units, but are not limited thereto.

For example, as shown in FIG. 9, the array substrate 10 includes a top insulation layer 900 at one side, away from the base substrate 100, of the conductive pattern 500. For example, the top insulation layer 900 may be the film layer, closest to the opposite substrate 20, of the array substrate 10. FIG. 9 also shows the conductive pattern 500, and the conductive pattern 500 is located on one side, close to the base substrate 100, of the top insulation layer 900. As can be seen from FIG. 9, the conductive pattern 500 is not laid as a whole, but as a pattern having a characteristic shape. For clarity of illustration, some of the film layers are omitted from the array substrate of FIG. 9.

For example, as shown in FIGS. 4 and 9, because the conductive pattern 500 is closer to the base substrate 100 than the top insulation layer 900, and a thickness of the top insulation layer 900 is relatively uniform, it is possible to make the top insulation layer 900 include a first insulation portion 901 and a second insulation portion 902 connected to each other. As shown in FIG. 4, the first insulation portion 901 covers the conductive pattern 500, and the orthographic projection, on the base substrate 100, of the second insulation portion 902 does not overlap the at least a portion of the orthographic projection, on the base substrate 100, of the conductive pattern 500.

For example, the first insulation layer 901 completely covers the conductive pattern 500 such that the orthographic projection, on the base substrate 100, of the conductive pattern 500 falls into an orthographic projection, on the base substrate 100, of the first insulation layer 901.

For example, as shown in FIG. 9 and FIG. 4, in the third direction Z, a position where the first insulation portion 901 and the second insulation portion 902 are connected to each other has a step difference H. A surface, away from the conductive pattern 500, of the first insulation portion 901 is farther away from the base substrate 100 than a surface, away from the conductive pattern 500, of the second insulation portion 902, and the orthographic projection, on the base substrate 100, of the supporting structure 210 falls into the orthographic projection, on the base substrate 100, of the second insulation portion 902. For example, the step difference H between the first insulation portion 901 and the second insulation portion 902 may be substantially equal to the thickness of the conductive pattern 500. For example, the step difference H may be 0.3 μm to 1 μm, such as at least one of 0.3 um to 0.5 μm, 0.5 μm to 0.8 μm, 0.6 μm to 0.9 μm, and 0.3 μm to 0.7 μm, but is not limited thereto.

With such arrangement, as shown in FIG. 9 and FIG. 4, the second insulation portion 902 can be recessed with respect to the first insulation portion 901, and the supporting structure 210 can be located on the second insulation portion 902, such that the first insulation portion 901 can act as a stop for the supporting structure 210 to limit the sliding of the supporting structure 210 on the surface of the second insulation portion 902, thereby reducing the risk of the supporting structure 210 scratching the top insulation layer 900, and further reducing the risk of poor display such as Mura.

For example, as shown in FIG. 9, the top insulation layer 900 in the above-described embodiment may be a first alignment layer 110, and the opposite substrate 20 may further have a second alignment layer 220. The second alignment layer 220 may be a film layer, closest to the array substrate 10, of the opposite substrate 20 and the second alignment layer 220 and the first alignment layer 110 face each other in the third direction Z. For example, the first alignment layer 110 and the second alignment layer 220 may collectively control the alignment state of the liquid crystal molecules 301 to facilitate an ordered arrangement of the liquid crystal molecules 301.

For example, as shown in FIG. 9, the plurality of supporting structures 210 are provided on the opposite substrate 20, and the first alignment layer 110 has a recess 205 in the region surrounded by at least a portion of the conductive pattern 500 to define the position of the supporting structure 210. For example, the orthographic projection, on the base substrate 100, of the supporting structure 210 at least partially overlaps with an orthographic projection, on the base substrate 100, of the recess 205. For example, the orthographic projection, on the base substrate 100, of the supporting structure 210 may be made fall into the orthographic projection, on the base substrate 100, of the recess 205, such that the first alignment layer 110 may effectively limit the movement of the supporting structure 210 in the direction parallel to the base substrate 100 while controlling the arrangement state of the liquid crystal molecules 301, advantageously reducing the risk of the supporting structure 210 scratching the first alignment layer 110.

It should be noted that in the embodiments of the present disclosure, as shown in FIG. 9, the metal structure 500 may not be in direct contact with the film layer, closest to the opposite substrate 20, of the array substrate 10 (for example, the top insulation layer or the first alignment layer 110 in the embodiments described above). For example, a plurality of other film layers may also be provided on the side, away from the base substrate 100, of the metal structure 500, so long as the film layer, closest to the opposite substrate 20, of the array substrate 10 has a recess and the risk of the supporting structure 210 scratching the film layer, closest to the opposite substrate 20, of the array substrate 10 can be reduced.

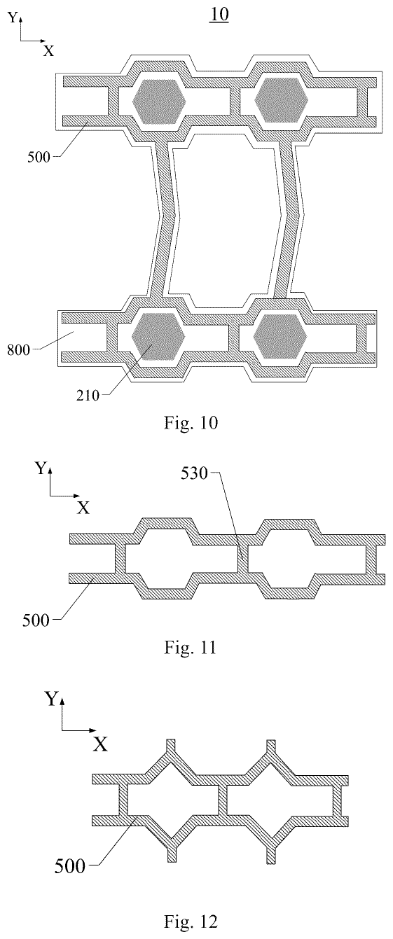

FIG. 10 is a partial cross-sectional diagram of the display panel of FIG. 9.

For example, as shown in FIG. 10, at least a portion of the orthographic projection, on the base substrate 100, of the conductive pattern 500 surrounds the orthographic projection, on the base substrate 100, of the supporting structure 210. For example, the orthographic projection, on the base substrate 100, of the supporting structure 210 may be any one of polygonal (e.g. octagonal), circular, and elliptical, and embodiments of the present disclosure do not limit this. For example, the orthographic projection, on the base substrate 100, of the conductive pattern units 510 (refer to FIG. 1) in the conductive pattern 500 may be in a shape of a closed loop, such that the supporting structure 210 may be located in the closed loop. For example, in some embodiments of the present disclosure, the orthographic projection, on the base substrate 100, of a portion, surrounding the supporting structure 210, of the conductive pattern 500 may also be in a shape of a non-closed loop, which is not limited.

For example, as shown in FIGS. 4 and 10, upon the supporting structure 210 being surrounded by at least a portion of the conductive pattern 500, the portion of the conductive pattern 500 limits movement of the supporting structure 210 in a direction parallel to the base substrate 100, so that the risk of the supporting structure 210 scratching the surface of the array substrate 10 (for example, the first alignment layer 110 in the array substrate 10) may be reduced.

FIG. 11 is a partial structural schematic diagram of the conductive pattern in FIG. 10.

For example, as shown in FIG. 11, in the second direction Y, portions, located on both sides of the same supporting structure 210 in the second direction Y, of the conductive pattern 500 are connected to each other. For example, the conductive pattern 500 may include a second connection portion 530, a main body extension direction of the portions, located on both sides of the same supporting structure 210 in the second direction Y, of the conductive pattern 500 is the first direction X, and the two portions may be connected by the second connection portion 530, so that an orthographic projection, on the base substrate, of the portion, surrounding one same supporting structure 210, of the conductive pattern 500 may be in a shape of closed loop. With such arrangement, the supporting structure 210 is circumferentially limited by the conductive pattern 500, thereby effectively reducing the risk of movement of the supporting structure 210 in the direction parallel to the base substrate 100.

FIG. 12 is a partial structural schematic diagram of another conductive pattern.

For example, the shape of the conductive pattern shown in FIG. 12 is different from the shape of the conductive pattern in FIG. 11, and the remaining features can be described with reference to the related description in the above-described embodiment, which will not be repeated.

For example, as shown in FIG. 10 and FIG. 12, in the second direction Y, portions, on both sides of the same supporting structure 210, of the conductive pattern in FIG. 12 include two corner portions opposite to each other, so as to correspond to the supporting structure 210 having a partially protruding structure, but it is not limited thereto. For example, upon the supporting structure 210 having a variety of different shapes according to design requirements, the shape and structure of the conductive pattern 500 may also be flexibly adjusted accordingly, so as to better limit movement of the supporting structure 210 in the direction parallel to the base substrate.

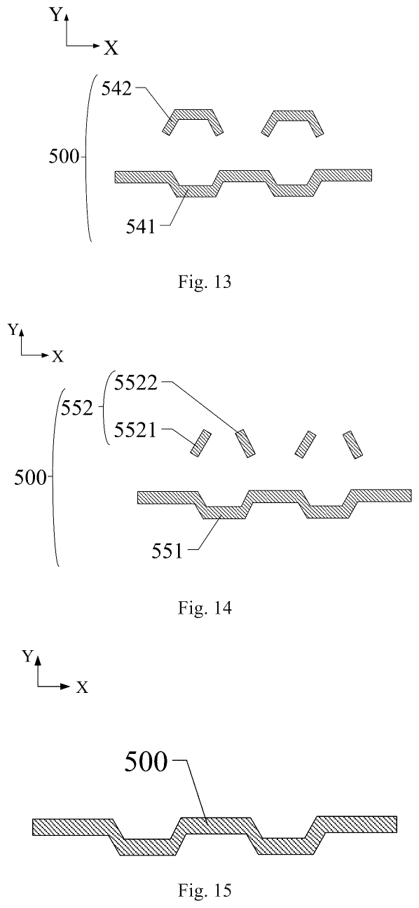

FIG. 13 is a partial structural schematic diagram of yet another conductive pattern.

For example, the shape of the conductive pattern shown in FIG. 13 is different from the shape of the conductive pattern in FIG. 11, and the remaining features can be described with reference to the related description in the above-described embodiment, which will not be repeated.

For example, as shown in FIG. 13, in the first direction X, at least portions, located between two adjacent supporting structures 210, of the conductive pattern 500 are disconnected from each other. For example, as shown in FIG. 10 and FIG. 13, the conductive pattern 500 may include a first conductive pattern portion 541 and a second conductive pattern portion 542 located on both sides of one same supporting structure 210 in the second direction Y, respectively, and the first conductive pattern portion 541 and the second conductive pattern portion 542 are not connected to each other. For example, in the first direction X, two first conductive pattern portions 541 located on one side of two adjacent supporting structures 210 are connected to each other, and two second conductive pattern portions 542 located on one side of two adjacent supporting structures 210 are not connected to each other. For example, in this arrangement, the portion, not surrounded by the conductive pattern 500, of the supporting structure 210 is less likely to slip, so that, with such arrangement, movement of the supporting structure 210 can be limited by the first conductive pattern portion 541 and the second conductive pattern portion 542.

FIG. 14 is a partial structural schematic diagram of yet another conductive pattern.

For example, the shape of the conductive pattern shown in FIG. 14 is different from the shape of the conductive pattern in FIG. 13, and the remaining features can be described with reference to the related description in the above-described embodiment, which will not be repeated.

For example, as shown in FIG. 14, in the first direction X, at least portions, located between two adjacent supporting structures 210, of the conductive pattern 500 are disconnected from each other. For example, as shown in FIG. 10 and FIG. 14, the conductive pattern 500 may include a first conductive pattern portion 551 and a second conductive pattern portion 552 located on both sides of one supporting structure 210 in the second direction Y, respectively, and the first conductive pattern portion 551 and the second conductive pattern portion 552 are not connected to each other, and the second conductive pattern portion 552 includes a first sub-conductive pattern portion 5521 and a second sub-conductive pattern portion 5522 spaced apart from each other. For example, in the first direction X, two first conductive pattern portions 541 located on one side of two adjacent supporting structures 210 are connected to each other, and two second conductive pattern portions 542 located on one side of two adjacent supporting structures 210 are not connected to each other. An orthographic projection, on the base substrate, of first sub-conductive pattern portion 5521 and the second sub-conductive pattern portion 5522 surrounding the supporting structure 210 is in a “ [symbol] ” shape so that the movement of the supporting structure 210 can be limited.

FIG. 15 is a partial structural schematic diagram of yet another conductive pattern.

For example, as shown in FIG. 10 and FIG. 15, in order to better limit the movement of the supporting structure 210 according to design requirements, the structure of the conductive pattern 500 is not limited to the structure shown in the above-mentioned embodiments. For example, in the second direction Y, portions, located on both sides of one supporting structure 210, of the conductive pattern 500 have different areas of the orthographic projections on the base substrate 100. For example, in some embodiments, the conductive pattern 500 may be provided on only one side of the supporting structure 210, such that movement of the supporting structure 210 toward the conductive pattern 500 close to the side may be reduced, but it is not limited thereto.

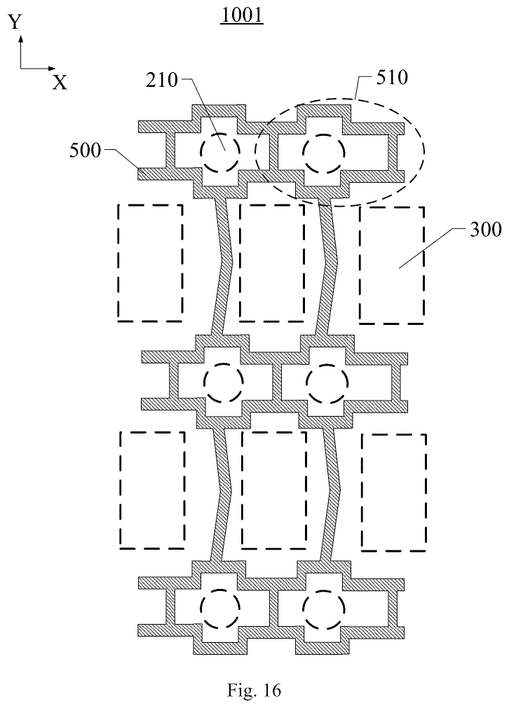

FIG. 16 is a partial schematic cross-sectional diagram of another display panel according to an embodiment of the present disclosure.

For example, as shown in FIG. 16, the display panel 1001 includes a plurality of pixel electrodes 300 and a plurality of supporting structures 210, the plurality of pixel electrodes 300 are provided in an array in the first direction X and the second direction Y, and the plurality of supporting structures 210 are provided in an array in the first direction X and the second direction Y, and an interval is between the orthographic projection, on the base substrate, of the pixel electrode 300 and the orthographic projection, on the base substrate, of the supporting structure 210. For example, the orthographic projection on the base substrate, of the supporting structure 210 is substantially circular, and an area of the orthographic projection, on the base substrate, of the supporting structure 210 is smaller than an area of the orthographic projection, on the base substrate, of the pixel electrode 300.

For example, as shown in FIG. 16, the display panel 1001 further includes a conductive pattern 500, and at least a portion of the conductive pattern 500 surrounds the supporting structure 210. For example, the conductive pattern 500 includes a plurality of conductive pattern units 510, and the supporting structure 210 is located in a region surrounded by the conductive pattern units 510. In the first direction X, portions, surrounding two adjacent supporting structures 210, of the conductive pattern 500 are connected to each other. In the second direction Y, portions, located on both sides of one same pixel electrode 300, of the conductive pattern 500 are connected to each other, so that, for example, the conductive pattern 500 is of a unitary construction, which is advantageous in reducing the square resistance of the conductive pattern 500 to facilitate signal diffusion in all directions. At the same time, the supporting structure 210 can be limited to slid in the direction parallel to the base substrate to reduce scratching of the array substrate in the display panel 1001, which is advantageous in reducing the occurrence of crosstalk and poor display such as Mura.

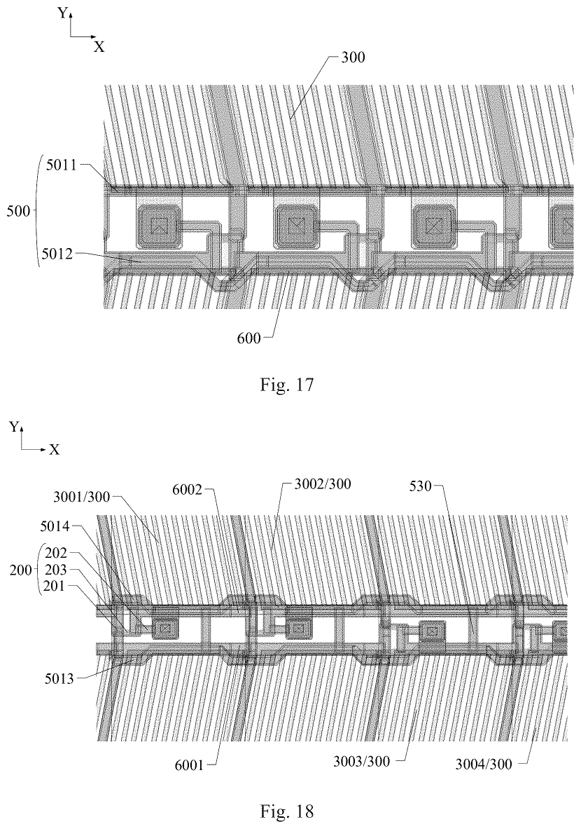

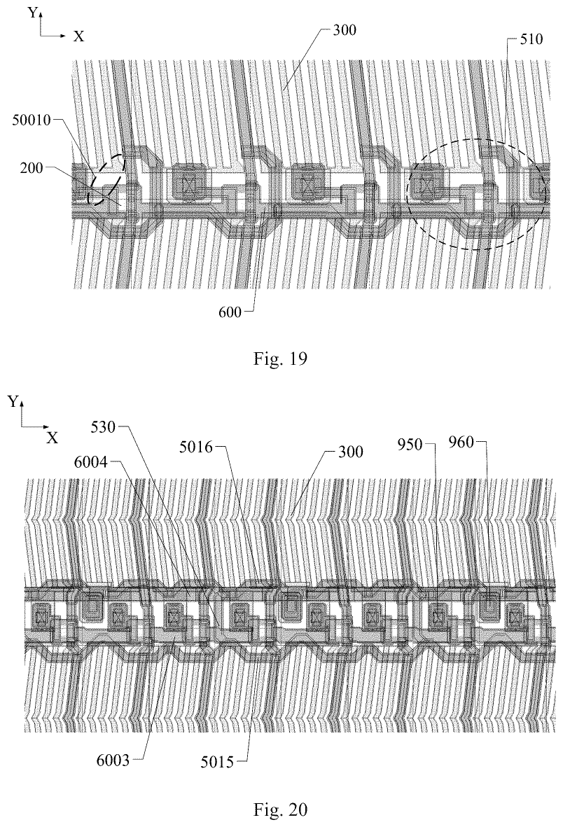

FIG. 17 is a partial structural schematic diagram of yet another conductive pattern; FIG. 18 is a partial structural schematic diagram of yet another conductive pattern; FIG. 19 is a partial structural schematic diagram of yet another conductive pattern; and FIG. 20 is a partial structural schematic diagram of yet another conductive pattern.

For example, as shown in FIG. 17, the conductive pattern 500 may include a first conductive pattern portion 5011 and a second conductive pattern portion 5012, and the first conductive pattern portion 5011 and the second conductive pattern portion 5012 are spaced apart in the second direction Y. The first conductive pattern portion 5011 extends in the first direction X, the direction in which the first conductive pattern portion 5011 extends is substantially a straight line, and the direction in which the second conductive pattern portion 5012 extends is a curved line. The orthographic projection, on the base substrate, of the second conductive pattern portion 5012 at least partially overlaps with the orthographic projection, on the base substrate, of the gate line 600. For example, an orthographic projection, on the base substrate, of a portion, extending in the first direction X, of the second conductive pattern portion 5012 falls into an orthographic projection, on the base substrate, of the gate line 600, such that layout space can be saved and the pixel opening ratio can be increased. For example, the second conductive pattern portion 5012 includes a straight line segment portion extending in the first direction X between adjacent data lines, and the orthographic projection, on the base substrate, of the straight line segment portion falls into the orthographic projection, on the base substrate, of the gate line 600.

For example, as shown in FIG. 18, the conductive pattern 500 includes a first conductive pattern portion 5013 and a second conductive pattern portion 5014, the extension directions of the first conductive pattern portion 5013 and the second conductive pattern portion 5014 are both curved lines, and the first conductive pattern portion 5013 and the second conductive pattern portion 5014 are connected by a second connection portion 530. The display panel includes a first gate line 6001 and a second gate line 6002, and both the first gate line 6001 and the second gate line 6002 extend in the first direction X. An orthographic projection, on the base substrate, of the first conductive pattern portion 5013 at least partially overlaps an orthographic projection, on the base substrate, of the first gate line 6001, and an orthographic projection, on the base substrate, of the second conductive pattern portion 5014 at least partially overlaps an orthographic projection, on the base substrate, of the second gate line 6002. The display panel includes a first pixel electrode 3001 and a second pixel electrode 3002 adjacent in the first direction X, and a third pixel electrode 3003 and a fourth pixel electrode 3004 adjacent in the first direction X. The first pixel electrode 3001 and the third pixel electrode 3003 are located in different rows in the second direction Y. For example, the drain electrode 202 adjacent to the gate electrode 203 connected to the first gate line 6001 is connected to the first pixel electrode 3001 through a via hole. For example, the drain electrode 202 adjacent to the gate electrode 203 connected to the second gate line 6002 is connected to the third pixel electrode 3003 through a via hole.

For example, as shown in FIG. 19, the conductive pattern 500 includes a plurality of openings 50010. For example, the conductive pattern 500 includes a plurality of conductive pattern units 510, the orthographic projection, on the base substrate, of the conductive pattern unit 510 is in a shape of a non-closed loop, and at least a portion of the pixel electrode 300 are located in the region of the loop, such that the distance between adjacent pixel electrodes 300 in the second direction Y can be reduced to increase the pixel opening ratio.

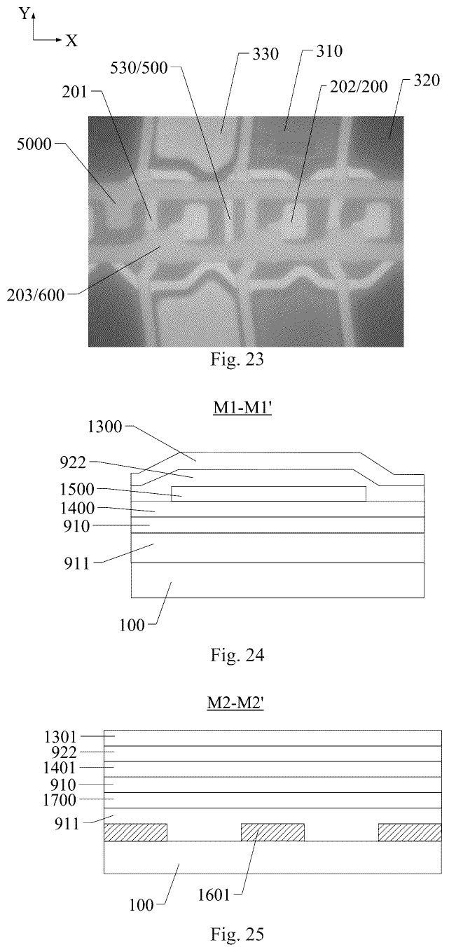

For example, as shown in FIG. 20, the conductive pattern 500 may include a first conductive pattern portion 5015 and a second conductive pattern portion 5016, the first conductive pattern portion 5015 and the second conductive pattern portion 5016 are spaced apart in the second direction Y, and the first conductive pattern portion 5015 and the second conductive pattern portion 5016 are connected by a second connection portion 530. The extension directions of the first conductive pattern portion 5015 and the second conductive pattern portion 5016 are curved lines. The display panel includes a first gate line 6003 and a second gate line 6004, and both the first gate line 6003 and the second gate line 6004 extend in the first direction X. An orthographic projection, on the base substrate, of the first conductive pattern portion 5015 at least partially overlaps with an orthographic projection, on the base substrate, of the first gate line 6003, and an orthographic projection, on the base substrate, of the second conductive pattern portion 5016 at least partially overlaps with an orthographic projection, on the base substrate, of the second gate line 6004. For example, the pixel electrode 300 may be connected to the drain electrode of the thin film transistor through the via hole 950, and at least a portion of the structure of the pixel electrode 300 is connected to a common electrode line through the via hole 960 (for the arrangement mode of the common electrode line, please refer to the relevant description about FIG. 22-FIG. 23 in the following embodiments). For example, a spacing is provided between an orthographic projection, on the base substrate, of the via hole 950 and an orthographic projection, on the base substrate, of the via hole 960 to reduce the risk of poor signal generation.

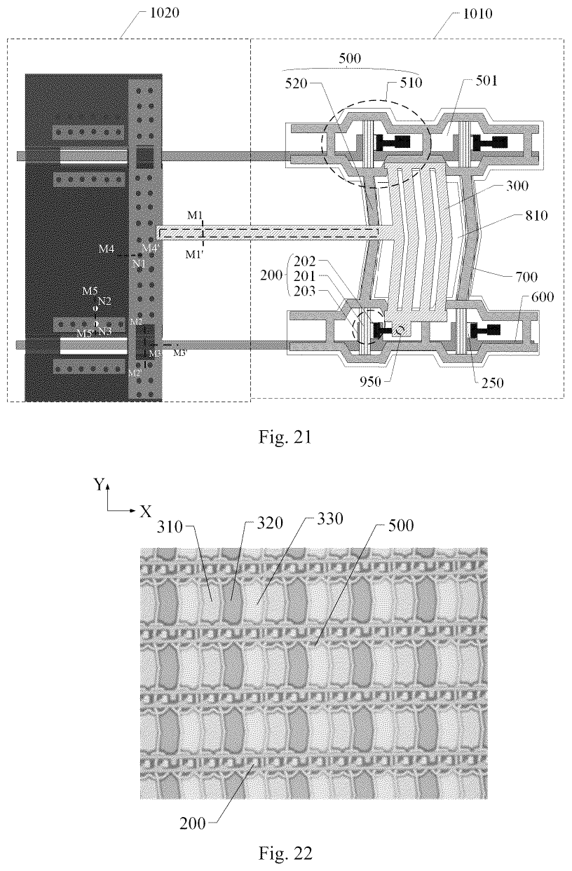

FIG. 21 is a schematic diagram of a connection between a display region and a peripheral region of the display panel provided by an embodiment of the present disclosure; FIG. 22 is a partial structural schematic diagram of the display region in FIG. 21; and FIG. 23 is an enlarged diagram of a partial region of FIG. 22.

For example, as shown in FIG. 21, the display panel includes a display region 1010 and a peripheral region 1020, and the peripheral region 1020 is located on at least one side of the display region 1010. For example, the peripheral region 1020 may be provided around the display region 1010, but it is not limited thereto.

For example, as shown in FIG. 22, a plurality of sub-pixels are provided in the display region 1010 when viewed from a side of the array substrate of the display panel, and the plurality of sub-pixels are arranged in an array in the first direction X and the second direction Y to form a plurality of pixel rows and a plurality of pixel columns. For example, the plurality of sub-pixels include a first sub-pixel 310, a second sub-pixel 320, and a third sub-pixel 330. For example, the first sub-pixel 310, the second sub-pixel 320 and the third sub-pixel 330 are respectively sub-pixels emitting light of different colors. For example, one of the first sub-pixel 310 and the second sub-pixel 320 may be a red sub-pixel emitting red light, the other may be a blue sub-pixel emitting blue light, and the third sub-pixel 330 may be a green sub-pixel emitting green light. For example, the first sub-pixel 310 is a blue sub-pixel and the second sub-pixel 320 is a red sub-pixel. Of course, the colors of the first sub-pixel 310, the second sub-pixel 320, and the third sub-pixel 330 may be interchanged. Of course, the embodiments of the present disclosure are not limited thereto, and a size of an area of a light emitting region of each color of sub-pixel may be set according to actual product requirements.

For example, as shown in FIGS. 22 and 23, a conductive pattern 500 and a source electrode 201, a drain electrode 202, and a gate electrode 203 of a thin film transistor 200 are provided between two adjacent rows of sub-pixels, and a portion of a structure of the thin film transistor 200 is not covered by the conductive pattern 500, so as to detect an operating state of the thin film transistor 200.

For example, a quantity of second connection portions 530 in the conductive pattern 500 in FIG. 23 may be reduced according to design requirements as compared to the conductive pattern 500 shown in FIG. 11. For example, in the second direction Y, the second connection portion 530 is provided between two adjacent third sub-pixels 330, and the second connection portion 530 may not be provided between two adjacent second sub-pixels 320 to better accommodate the layout space. For example, in some embodiments, in the second direction Y, the second connection portion 530 may be provided only between two adjacent first sub-pixels 310, and the second connection portion 530 may not be provided between two adjacent third sub-pixels 330, but it is not limited thereto. For example, in some embodiments, the quantity and location of the second connection portions 530 may be flexibly adjusted according to the layout space.

For example, as shown in FIGS. 21 and 23, the display panel further includes a common electrode line 5000, and the common electrode line 5000 extends in the first direction X. For example, the common electrode line 5000 may be located on the same layer as the gate line 600. For example, the conductive pattern 500 may be located on one side, away from the base substrate, of the common electrode 5000, and the common electrode line 5000 may be electrically connected to the conductive pattern 500, such that the square resistance of the common electrode 400 (as shown in FIG. 4) may be further reduced to improve uniformity upon the signal of the common electrode 400 being diffused.

For example, as shown in FIG. 23, an orthographic projection, on the base substrate, of the common electrode line 5000 does not overlap the gate line 600, so as to reduce signal interference.

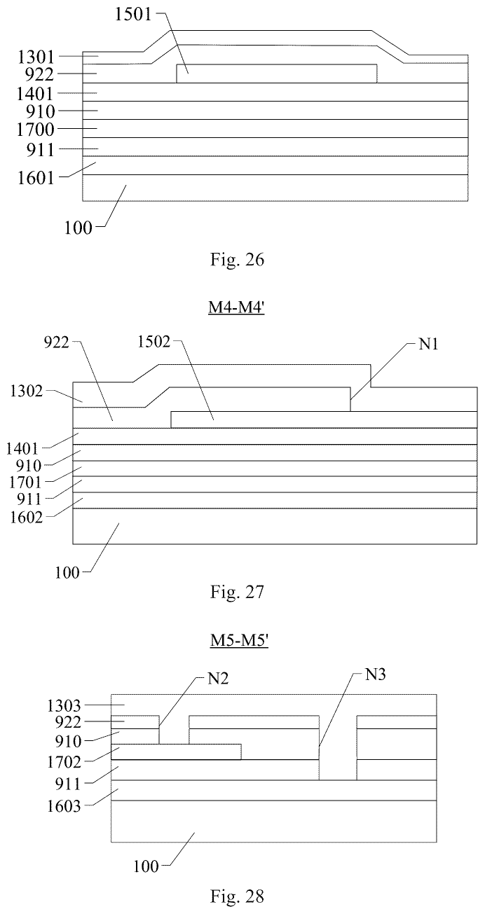

FIG. 24 is a schematic cross-sectional diagram of the array substrate of FIG. 21 taken along line M1-M1′; FIG. 25 is a schematic cross-sectional diagram of the array substrate of FIG. 21 taken along line M2-M2′; FIG. 26 is a schematic cross-sectional diagram of the array substrate of FIG. 21 taken along line M3-M3′; FIG. 27 is a schematic cross-sectional diagram of the array substrate of FIG. 21 taken along line M4-M4′; and FIG. 28 is a schematic cross-sectional diagram of the array substrate of FIG. 21 taken along line M5-M5′.

For example, as shown in FIG. 21, some the signal lines in the display region 1010 are connected to the peripheral region 1020, so as to apply driving signals from the peripheral region 1020 to the display region 1010.

For example, as shown in FIG. 21 and FIG. 24, the first insulation layer 911, the planarization layer 910, a connector 1400 on the same layer as the common electrode 400, a connector 1500 on the same layer as the conductive pattern 500, the second insulation layer 922, and a connector 1300 on the same layer as the pixel electrode 300 are sequentially stacked on the base substrate 100 at a position that the line M1-M1′ cuts.

For example, as shown in FIG. 21 and FIG. 25, the position cut by the line M2-M2′ is located in a hollowed-out region of the third metal layer (that is, the film layer where the conductive pattern 500 is located), a connector 1601 on the same layer as the gate line 600, the first insulation layer 911, a connector 1700 on the same layer as the data line 700, the planarization layer 910, a connector 1401 on the same layer as the common electrode 400, the second insulation layer 922 and a connector 1301 on the same layer as the pixel electrode 300 are sequentially stacked on the base substrate 100. For example, in the second direction Y, the two sides of the connector 1601 are further provided with other connectors at the same layer at intervals. For example, the connector 1601 may transmit a scanning signal from the peripheral region 1020 to the display region 1010 to control the switching on or off of the thin film transistor 200 in the display region 1010.

For example, as shown in FIG. 21 and FIG. 26, the position cut by the line M3-M3′ is located in an edge portion of the hollowed-out region of the third metal layer, and at this position, a structure of the connector 1401 located at the same layer as the common electrode 400 and below is substantially the same as the structure shown in FIG. 24. A connector 1501 on the same layer as the conductive pattern 500 is provided on the connector 1401, and the second insulation layer 922 and a connector 1301 on the same layer as the pixel electrode 300 are provided on the conductive pattern 500.

For example, as shown in FIG. 21 and FIG. 27, at the position that the line M4-M4′ cuts, a connector 1602 located on the same layer as the gate line 600, the first insulation layer 911, a connector 1701 located on the same layer as the data line 700 (as shown in FIG. 4), the planarization layer 910, a connector 1401 located on the same layer as the common electrode 400, a connector 1502 located on the same layer as the conductive pattern 500 are sequentially provided, the second insulation layer 922 is located on the connector 1502, and a connector 1302 located on the same layer as the pixel electrode 300 is located on the second insulation layer 922 and is connected to the connector 1502 through a via hole N1.

For example, as shown in FIG. 21 and FIG. 28, at the position that the line M5-M5′ cuts, a connector 1603 located on the same layer as the gate line 600, the first insulation layer 911, a connector 1702 located on the same layer as the data line 700 (as shown in FIG. 4), and the planarization layer 910 are sequentially provided, a second insulation layer 922 is located on the planarization layer 910, and a connector 1303 located on the same layer as the pixel electrode 300 is located on the second insulation layer 922. The connector 1303 is connected to the connector 1702 through a via hole N2, and the connector 1303 is connected to the connector 1603 through a via hole N3.

In the embodiments of the present disclosure, with respect to the thin film transistor 200, the names of the source electrode 201 and the drain electrode 202 of the thin film transistor 200 are interchangeable. Of course, one of the source electrode 201 and the drain electrode 202 of the thin film transistor 200 may also be referred to as a first electrode, and the other of the source electrode 201 and the drain electrode 202 of the thin film transistor 200 may also be referred to as a second electrode. The gate electrode 203 of the thin film transistor 200 may be referred to as a gate electrode.

In embodiments of the present disclosure, both the pixel electrode 300 and the common electrode 400 may be referred to as display electrodes. For example, one of the pixel electrode 300 and the common electrode 400 may be referred to as a first display electrode, and the other of the pixel electrode 300 and the common electrode 400 may be referred to as a second display electrode.

For example, the array substrate according to the embodiments of the present disclosure may be fabricated using an oxide back channel etch technique.

For example, in embodiments of the present disclosure, the supporting structure 15 may also be referred to as a spacer.

The embodiments of the present disclosure are described as an example in which the pixel electrode 300 is located on the side, away from the base substrate, of the common electrode 400, namely, the pixel electrode 300 is formed after the common electrode 400, but it is not limited thereto. The positions of the pixel electrode 300 and the common electrode 400 can be adjusted as needed. For example, in some embodiments, the common electrode 400 is located on one side, away from the base substrate, of the pixel electrode 300. In embodiments of the present disclosure, one, away from the base substrate, of the common electrode 400 and the pixel electrode 300 has a slit, so as to facilitate the formation of an electric field by the common electrode 400 and the pixel electrode 300.

The embodiment of the present disclosure is exemplified by, but not limited to, the conductive pattern 500 being located above the common electrode 400, that is, the conductive pattern 500 being formed after the common electrode 400. In other embodiments, the conductive pattern 500 may be formed before the common electrode 400 is formed, namely, the common electrode 400 is located above the conductive pattern 500.

In embodiments of the present disclosure, elements located in the same layer may be formed through the same patterning process from the same film layer. For example, elements located in the same layer may be located on a surface, away from the base substrate, of the same element.

It is noted that in the drawings used to describe embodiments of the present disclosure, the thickness of layers or regions are exaggerated for clarity. It will be understood that when an element such as a layer, film, region or substrate is referred to as being “above” or “under” another element, it can be “directly above” or “under” the other element, or intervening elements may be present.

In embodiments of the present disclosure, the patterning or patterning process may include only a photolithographic process, or a photolithographic process as well as an etching step, or may include other processes for forming a predetermined pattern, such as printing, inkjetting, etc. The photolithographic process refers to a craft process including film formation, exposure and development, and uses a photoresist, a mask plate and an exposure machine to form a pattern. A corresponding patterning process may be selected based on the structures formed in embodiments of the present disclosure.

In embodiments of the present disclosure, components located at different layers are formed from different film layers by different patterning processes.

At least one embodiment of the present disclosure further provides a display apparatus, and the display apparatus includes a display panel as described in any one of the embodiments above. Thus, the display apparatus includes the above-mentioned display panel, and therefore, the technical effects of the above-mentioned display panel can also be exhibited on the display apparatus, and the description thereof will not be repeated here.

The following statements should be noted:
(1) The accompanying drawings related to the embodiment(s) of the present disclosure involve only the structure(s) in connection with the embodiment(s) of the present disclosure, and other structure(s) can be referred to common design(s).
(2) In case of no conflict, features in one embodiment or in different embodiments of the present disclosure can be combined.

The foregoing is merely exemplary embodiments of the disclosure, but is not used to limit the protection scope of the disclosure. The protection scope of the disclosure shall be defined by the attached claims.

1: An array substrate, comprising:
a base substrate;
a thin film transistor, located on the base substrate, wherein the thin film transistor comprises a source electrode, a drain electrode and a gate electrode;
a pixel electrode, electrically connected to the drain electrode;
a common electrode, configured to form an electric field with the pixel electrode;
a conductive pattern, located at a different layer from the common electrode; and
a plurality of gate lines, wherein the plurality of gate lines extend in a first direction, the plurality of gate lines are provided at intervals in a second direction, one of the plurality of gate lines is electrically connected to the gate electrode of the thin film transistor, the first direction and the second direction are both parallel to the base substrate, and the first direction intersects with the second direction,
wherein the conductive pattern is electrically connected to the common electrode, and an orthographic projection, on the base substrate, of the gate line at least partially overlaps with an orthographic projection, on the base substrate, of the conductive pattern.

2: The array substrate according to claim 1, further comprising an active pattern connected to the source electrode and the drain electrode of the thin film transistor, respectively, and at least partially overlapping with the gate electrode,
wherein an orthographic projection, on the base substrate, of the active pattern at most partially overlaps with the orthographic projection, on the base substrate, of the conductive pattern.

3: The array substrate according to claim 2, wherein a spacing is provided between the orthographic projection, on the base substrate, of the active pattern and the orthographic projection, on the base substrate, of the conductive pattern.

4: The array substrate according to claim 2, wherein the conductive pattern comprises a plurality of conductive pattern units, and at least a portion of an orthographic projection, on the base substrate, of one of the plurality of conductive pattern units surrounds the orthographic projection, on the base substrate, of the active pattern.

5. (canceled)

6: The array substrate according to claim 4, wherein adjacent conductive pattern units are at least partially connected to each other in the first direction.

7: The array substrate according to any one of claim 4, wherein the conductive pattern further comprises a plurality of connection portions, one of the plurality of connection portions extends in the second direction, and both ends of the connection portion are respectively connected to two conductive pattern units adjacent in the second direction.

8: The array substrate according to claim 7, further comprising:
a plurality of data lines, wherein one of the plurality of data lines extends in the second direction, and the data line is electrically connected to the source electrode,
wherein an orthographic projection, on the base substrate, of the connection portion falls into an orthographic projection, on the base substrate, of a portion of the data line between two conductive pattern units connected by the connection portion.

9. (canceled)

10: The array substrate according to any one of claim 1, wherein the conductive pattern is located on one side, away from the base substrate, of the common electrode in a direction perpendicular to the base substrate.

11: The array substrate according to claim 10, wherein in the direction perpendicular to the base substrate the common electrode is closer to the base substrate than the pixel electrode, and the conductive pattern is located between the common electrode and the pixel electrode.

12. (canceled)

13: A display panel, comprising an array substrate and an opposite substrate provided opposite to the array substrate to form a cell, wherein
the array substrate, comprises:
a base substrate;
a thin film transistor, located on the base substrate, wherein the thin film transistor comprises a source electrode, a drain electrode and a gate electrode;
a pixel electrode, electrically connected to the drain electrode;
a common electrode, configured to form an electric field with the pixel electrode;
a conductive pattern, located at a different layer from the common electrode; and
a plurality of gate lines, wherein the plurality of gate lines extend in a first direction, the plurality of gate lines are provided at intervals in a second direction, one of the plurality of gate lines is electrically connected to the gate electrode of the thin film transistor, the first direction and the second direction are both parallel to the base substrate, and the first direction intersects with the second direction,
wherein the conductive pattern is electrically connected to the common electrode, and an orthographic projection, on the base substrate, of the gate line at least partially overlaps with an orthographic projection, on the base substrate, of the conductive pattern.

14: The display panel according to claim 13, wherein the opposite substrate comprises a light-shielding pattern, and an orthographic projection, on the base substrate, of the conductive pattern, an orthographic projection, on the base substrate, of the data line and an orthographic projection, on the base substrate, of the gate line all fall within an orthographic projection, on the base substrate, of the light-shielding pattern.

15: The display panel according to claim 14, wherein the light-shielding pattern comprises a plurality of openings, and at least a portion of the pixel electrode is located in one of the plurality of openings, and
the array substrate further comprises a planarization layer, the planarization layer is located on one side, close to the conductive pattern, of the pixel electrode, the drain electrode is electrically connected to the pixel electrode through a via hole penetrating the planarization layer, and an orthographic projection, on the base substrate, of the via hole does not overlap with an orthographic projection, on the base substrate, of the conductive pattern unit.

16-18. (canceled)

19: The display panel according to claim 13, wherein the display panel further comprises a plurality of supporting structures, one of the plurality of supporting structures is located between the array substrate and the base substrate to support a cell thickness.

20: The display panel according to claim 19, wherein the array substrate comprises a top insulation layer located on one side, away from the base substrate, of the conductive pattern,
the top insulation layer comprises a first insulation portion and a second insulation portion connected to each other, the first insulation portion covers the conductive pattern, and an orthographic projection, on the base substrate, of the second insulation portion does not overlap with at least a portion of the orthographic projection, on the base substrate, of the conductive pattern, and
a position where the first insulation portion and the second insulation portion are connected to each other has a step difference in a direction perpendicular to the base substrate, a surface, away from the conductive pattern, of the first insulation portion is farther away from the base substrate than a surface, away from the conductive pattern, of the second insulation portion, and an orthographic projection, on the base substrate, of the supporting structure falls into the orthographic projection, on the base substrate, of the second insulation portion.

21: The display panel according to claim 19, wherein at least a portion of the orthographic projection, on the base substrate, of the conductive pattern surrounds an orthographic projection, on the base substrate, of the supporting structure.

22: The display panel according to claim 19, wherein in the second direction, portions, located at both sides of one supporting structure in the second direction, of the conductive pattern are connected to each other.

23: The display panel according to claim 19, wherein in the first direction, portions of the conductive pattern between two adjacent supporting structures are at least partially disconnected from each other.

24: The display panel according to claim 19, wherein in the second direction, areas of the orthographic projections, on the base substrate, of the portions, located at both sides of one supporting structure, of the conductive pattern are different.

25: The display panel according to any one of claim 19, wherein the array substrate has a first alignment layer, the opposite substrate has a second alignment layer, the plurality of supporting structures are provided on the opposite substrate, and the first alignment layer has a recess in a region enclosed by at least a portion of the conductive pattern to define a position of the supporting structure,
the orthographic projection, on the base substrate, of the supporting structure at least partially overlaps with an orthographic projection, on the base substrate, of the recess.

26-27. (canceled)

28: A display apparatus, comprising a display panel, wherein the display panel comprises an array substrate and an opposite substrate provided opposite to the array substrate to form a cell, and
the array substrate, comprises:
a base substrate;
a thin film transistor, located on the base substrate, wherein the thin film transistor comprises a source electrode, a drain electrode and a gate electrode;
a pixel electrode, electrically connected to the drain electrode;
a common electrode, configured to form an electric field with the pixel electrode;
a conductive pattern, located at a different layer from the common electrode; and
a plurality of gate lines, wherein the plurality of gate lines extend in a first direction, the plurality of gate lines are provided at intervals in a second direction, one of the plurality of gate lines is electrically connected to the gate electrode of the thin film transistor, the first direction and the second direction are both parallel to the base substrate, and the first direction intersects with the second direction,
wherein the conductive pattern is electrically connected to the common electrode, and an orthographic projection, on the base substrate, of the gate line at least partially overlaps with an orthographic projection, on the base substrate, of the conductive pattern.
